(19) United States
(12) Patent Application Publication
(10) Pub. No.: US 2009/0040302 A1
(43) Pub. Date: Feb. 12, 2009

(54) Automated surveillance system

(76) Inventor: Stuart Thompson, Kent (GB)

Correspondence Address: ARENT FOX LLP, 1050 CONNECTICUT AVENUE, N.W., SUITE 400, WASHINGTON, DC, 20036, US

(21) Appl. No.: 11/918,881

(22) PCT Filed: Apr. 19, 2006
(86) PCT No.: PCT/GB2006/001414

§ 371 Date: Oct. 19, 2007

(30) Foreign Application Priority Data
Apr. 19, 2005 (GB) 0507869.6

(51) Int. Cl. H04N 7/18

(52) U.S. Cl. 348/143; 348/E07.085

(57) ABSTRACT

An automated intelligent surveillance system comprises one or more fixed reference cameras to spatially map and observe a panoramic field of view, together with a movable narrow-field high resolution camera which is controlled in pan tilt & zoom, and a computing device. The computing device is capable of analysing the reference images received from anywhere within the panoramic field of view, and identifying the presence of specific types of object or specific behaviours of objects. The computing device uses the outcome of this analysis to direct the movable camera to the appropriate area of the spatial map to cause it to zoom in to gather close-up images of one or more of the selected objects or events of interest. These images are recorded synchronously with the related wide angle reference images, in a high speed random access store within the computing device. The parameters defining an object or event as being of interest may be pre-set, user selected, or adaptively learned by the computing device.

It is known to use one or more reference cameras to control the direction and zoom of a movable camera, the movement of which may be controllable in Pan, Tilt & Zoom (“PTZ”), for surveillance purposes. WO2004/042667, “Surveillance Device”, describes such a device

The present invention comprises a device, and in particular its method of operation, permitting such control to be exercised intelligently and automatically, so as to obtain high quality auditable data, and to record such data in such a coordinated and adequately tamper-proof manner as to permit its successful use as evidence, both of events and of identity, in a court of law.

The essence of this requirement is that wide angle event data and high resolution identity data are automatically and intelligently captured simultaneously and the records of this data are rigorously linked and identified as to time of image capture and location of the event.

The device of the present invention may be a device in accordance with WO2004/042667, but need not necessarily be so.

The invention provides a means of:
a. mapping a panoramic vista of a full 360°, or part thereof, surrounding an observation point in the form of an electronic image of a virtual map;
b. intelligently analysing the contents of that image;
c. directing a movable high resolution narrow field camera to the appropriate co-ordinates when the image data received indicates some activity (or lack of activity) deemed, on the basis of preset or adaptively learned decision rules and “interest criteria”, to be worthy of interest.

The movable camera may be controlled spatially in pan and tilt (which in polar co-ordinate terms equate to bearing and elevation) and also in zoom. This control may be exercised either in response to wholly external information, or to self-referential information (including, for example, an “auto-zoom” capability) or to a combination of the two.

The invention thus comprises four main elements integrated into a single invention:
a. spatial mapping by fixed reference cameras and the calibration of this map into a defined system of co-ordinates;
b. identification and location of certain events occurring within the mapped area;
c. control of the PTZ camera in relation to the events and their locating co-ordinates to permit enhanced observation of the events;
d. creating an evidential record of the events, including date and time, wide angle reference images of the event, and high resolution close-up images sufficient to identify persons involved in the event.

### Creation and Monitoring of Virtual Map

The reference image collectors (typically CCTV cameras and hereafter referred to generically as “cameras”) are so arranged that their fields of view form a spherical mosaic or a subset mosaic thereof. Typically this subset is a horizontal circular, or part circular, band of images. Typically this band will comprise images from cameras typically mounted at a significant height to increase their optical or quasi-optical “line of sight” field of view past ground-level obstructions, and with their fields of view depressed below the horizontal (e.g., with the top edge of the field of view just below the natural horizon), so as to map space and activity on or near the ground.

The reference cameras monitor the whole of this composite panoramic view continuously. This panoramic view when rendered into data form creates a virtual map of the scene, and various means of imposing a co-ordinate reference system onto this map are known to those skilled in the art. For the purposes of controlling a pan and tilt camera located at known fixed point, polar coordinates may be favoured.

### Sensor Configuration

In general, the reference cameras will be spatially fixed (although provision may be made for adjusting them to alternative preset alignments, for example to permit different angles of depression relative to the horizon) and arranged with minimum overlap between their fields of view.

Provision may be made to enhance the reference camera data by sensors for additional forms of data, such as for example imaging from alternative bands of the e-m spectrum, or acoustic information. Conversely certain bands of the e-m spectrum may be filtered out to focus attention on specific subjects, or assist in recognition of specific phenomena such as fire, smoke, etc,

### Image Overlap

The mosaic will be subject to overlap at the edges of the fields of view. This means that this area of overlap is being watched by two cameras. Where the sensor arrays which gather the image data are planar, the two images received from the overlap areas will differ, one being subject to right hand and the other to left hand “edge error”. They will thus not represent the appropriate co-ordinates in the same way.

This will create ambiguities in the mapped position of a specific point. This ambiguity may be dealt with or removed by various means. A means may be provided to “mask” (i.e. discard data received from) the overlapping areas, or at least the greater part of them; each point will then have a unique location reference on the spatial map. Alternatively, the sensor arrays used to gather the image data may be arranged to lie on the surface of a sphere whose centre lies at the centre of the lens; in such an arrangement the images received from the overlap areas will be orthogonal and identical, and no ambiguity arises. Alternatively in those areas of the image which are subject to edge error, the image may be converted to an orthogonal form by the application of appropriate mathematical transforms to the data. Alternatively some form of averaging may be used for data from the ambiguous area.

### Parallax and Calibration

Having created an integrated co-ordinate system covering the whole mosaic field of view, a PTZ camera can now be directed to any point on that co-ordinate grid. If the centre of panning rotation of the PTZ is co-located with the centre of the ring of reference cameras, the measurement of bearings of points on the grid can theoretically be precise, since the lines of sight of all cameras will be radial to a common vertical axis. Parallax error in bearing may therefore be arranged to be insignificant.

However, since it is then impossible for the PTZ camera and the reference cameras to occupy the same plane, measurement of elevation will of necessity be subject to parallax effects, and objects at different distances from the cameras will have differing parallax errors. It is therefore necessary to have a calibration means for synchronizing the PTZ camera alignment with the reference mosaic to minimize such errors.

In principle, they can both be calibrated in absolute terms (e.g. relative to the horizon and the compass)—this would lead to them both using the same angular elevation setting, and their bore-sights would thus be parallel—i.e., there would be no parallactic convergence in elevation and the PTZ camera would always be aligned on a point the same height above the reference cameras' view as the PTZ camera is mounted above it. If this vertical separation of the moving camera from the reference cameras is sufficiently small, its significance, in terms of the amount of misalignment of the bore-sight at the event being observed, will be negligible.

Alternatively they may be calibrated by a human operator identifying a number of fixed points as viewed on both the fixed reference camera and the movable camera, and confirming to the data analysis system that these are the same point, and that their co-ordinates on the virtual map should be identical and locked to each other.

Whatever calibration method is chosen, the outcome of the calibration may be embedded permanently in the system and remain constant regardless of the site at which the system is to be installed. Alternatively the system may be so designed that calibration can be (or must be) undertaken by a human operator following installation of the system at a particular site.

### Data Analysis

The data from the whole panoramic mosaic of reference images is subjected to continuous analysis (which will typically but not necessarily be pixel analysis) to identify events of interest, defined on the basis of appropriate decision rules. Data received from the movable camera may also be subjected to such analysis. It will be apparent to those familiar with the art that there are many known intelligent algorithms to apply to such image data analysis. Neural networking techniques may also be used for such analysis.

Particular data concerning an image of an object which may be used as the basis of the decision rules to define an event of interest include, but are not limited to: size, shape, colour, location, speed of movement, acceleration, changes to any of the foregoing, and any temporal or spatial patterns followed by such changes.

The decision rules may also include predictive elements, and may either be externally imposed and permanent, or may change adaptively in response to accumulated data regarding events observed. They may trigger the initial identification of an event, or define the rules for tracking the ongoing event. An alerting means may be provided to provide an external alert system to, for example, a human operator or monitor at such time as the occurrence of an event is identified.

Particular sets of decision rules appropriate to particular environments may be defined and stored as detection profiles, so that an appropriate profile can readily be selected and applied for use in a given environment

### Multiple Events

In the event that more than one event of interest is occurring at a given time, the data analysis will identify all of these. Means may therefore be provided to:
a. log such multiple identifications for future reference, and/or
b. control the movable camera to observe them all on a cyclic basis.

When such multiple events are observed, priority decision rules applied to the analysis of the image data received by the reference cameras may be applied to this observation cycle, so as to partially or wholly concentrate the movable camera onto the collection of high resolution data from some of the events assessed as being of greater interest, at the expense of those of lesser interest.

### Data Storage and Presentation

The data from the reference cameras and from the movable camera will in general be stored as a series of images, which may if required be viewed in real time. However it is not necessary that the images be rendered in viewable form, unless this is required for record purposes and interpretation by human operator. The viewable image may in principle be of any part of the full mosaic recorded.

A suitable means for indexing and retrieval is provided. This includes means for ensuring that the records for the reference cameras and the moveable camera are synchronized to ensure a given image from the movable camera can be directly related to the image of the same event from a reference camera, and the date and time of the event can be accurately determined.

### SUMMARY OF THE INVENTION

This summary sets out the major broad features encompassed by the invention. However, it will be apparent from the foregoing description that the invention also comprises a variety of detailed features and may be embodied in a variety of ways. A given embodiment may not, and need not necessarily, include all the features here listed.

A method, (or a device operating substantially in accordance with that method) of:
a. systematically collecting sequential electronic reference images of a defined or surveyed space by means of a plurality of spatially fixed image collection devices (e.g. cameras);
b. creating from the said collected images a mosaicked virtual map of the area of interest, and applying to this map a system of spatial co-ordinates;
c. recording and storing all the said reference images in conjunction with related date and time data;
d. analysing said reference images in real time, in accordance with pre-defined or adaptive decision rules, to identify “events”, defined as occurrences of particular types of object exhibiting particular behaviour patterns;
e. providing an alert at such time as an “event” is identified;
f. automatically extracting, analysing and selecting relevant data from these images to identify and locate within the said space (by means of an appropriately defined co-ordinate system) all “events”;
g. automatically collecting additional enhanced images of the identified locations and the events occurring thereat by means of a further, movable, camera;
h. recording and storing these enhanced images and synchronizing them with a complete record of the original images collected, together with data on the time of occurrence and the location of the recording cameras;
i. indexing and providing rapid access to the stored synchronized images to permit ready retrieval of images either of specific identified events, or of occurrences at specific times, and means to create warranted true copies of these records for use in court.

1. A surveillance device in which wide-angle data from fixed reference image collectors are used to map a panoramic vista of a full 360°, or part thereof, surrounding an observation point in the form of an electronic image of a virtual map.

2. A surveillance device in which a computing device intelligently analyses the contents of an electronic virtual map of an area to discriminate those parts of the image which represent objects or events of interest as indicated by their meeting certain pre-defined selection criteria.

3. A surveillance device in which, in response to the receipt of image data which meets pre-defined selection criteria, a computing device directs a movable high resolution narrow field camera to the appropriate co-ordinates or to the appropriate degree of zoom or both to capture detailed images of selected objects or events.

4. A surveillance device in accordance with claim 1, in which wide angle event data from fixed reference image collectors and high resolution identity data from a high resolution pan tilt and zoom (PTZ) camera are automatically and intelligently captured simultaneously and in which the records of this data are rigorously linked and identified as to time of image capture and location of the event.

5. A device in accordance with claim 1 in which a co-ordinate reference system which may be Cartesian or polar or other is superimposed on the image within the computing device.

6. A device in accordance with claim 1 in which alternative or multiple sensors, such as for example sensors operating in different parts of the electro-magnetic spectrum, are used as sources of information to enhance the identification or the recording of objects or events of interest.

7. A device in accordance with claim 1 in which the reference image collectors are so arranged that their fields of view form a spherical mosaic or a subset mosaic thereof.

8. A device in accordance with claim 7 in which provision is made for elimination or correction of the images of those areas where overlap of the mosaic elements occurs.

9. A surveillance device in accordance with claim 2 in which the decision rules for the selection criteria are adaptively learned by the computing device.

10. A device in accordance with claim 2 in which the decision rules control movement of the movable camera to permit the cyclic close-up observation of two or more events occurring simultaneously, or control appropriate storage of the relevant reference camera images for later review, or both.

11. A device in accordance with claim 10 in which control of the observation cycle is itself subject to the computer device's decision rules so as to obtain more or better images of those events which are of greater interest.

12. A device in accordance with claim 1 in which the movable camera is controlled in pan or tilt or zoom or any or all of these either in response to wholly external information, or to self-referential information or to a combination of the two.

13. A device in accordance with claim 1 in which the computing device creates a simultaneous evidential record of the objects or events of interest, including all or some of: date and time, wide angle reference images, and high resolution close-up images sufficient to identify persons involved in the event.

14. A device in accordance with claim 1 in which one or more sources of information are blocked or filtered to enhance the identification or the recording of objects or events of interest.

15. A device in accordance with claim 1 in which the effects of parallax are removed or minimized by appropriate location of the movable camera relative to the reference cameras.

16. A device in accordance with claim 1 in which provision is made to overcome discrepancies the alignment of the movable camera with specific points on the electronic map, resulting from overlap errors, parallax errors or otherwise, by manual calibration in situ.

17. A device in accordance with claim 1 in which the computing device analyses data received from the movable camera as well as from the reference cameras.

18. A device in accordance with claim 1 in which the decision rules include predictive elements.

19. A device in accordance with claim 1 in which the decision rules trigger the initial identification of an event.

20. A device in accordance with claim 1 in which the decision rules define the rules for tracking the ongoing event.

21. A device in accordance with claim 1 equipped with an alerting means to provide an external alert system to, for example, a human operator or monitor at such time as the occurrence of an event is identified.

22. A device in accordance with claim 1 which provides means for ensuring that the images recorded for the reference cameras and the moveable camera are accurately synchronized with each other, and dated and timed.

23. A method of undertaking surveillance of a given area comprising the following automated artificial-intelligent operations:
a. systematically collecting sequential electronic reference images of a defined or surveyed space by means of a plurality of spatially fixed image collection devices;
b. creating from the said collected images a mosaicked virtual map of the area of interest, and applying to this map a system of spatial co-ordinates;
c. recording and storing all the said reference images in conjunction with related date and time data;
d. analysing said reference images in real time, in accordance with pre-defined or adaptive decision rules, to identify “events”, “events” being occurrences of particular types of object exhibiting particular behaviour patterns;
e. providing an alert at such time as an “event’ is identified;
f. automatically extracting, analysing and selecting relevant data from these images to identify and locate within the said space, by means of an appropriately defined co-ordinate system, all “events”;
g. automatically collecting additional enhanced images of the identified locations and the events occurring thereat by means of a further, movable, camera;
h. recording and storing these enhanced images and synchronizing them with a complete record of the original images collected, together with data on the time of occurrence and the location of the recording cameras; and
i. indexing and providing rapid access to the stored synchronized images to permit ready retrieval of images either of specific identified events, or of occurrences at specific times, and means to create warranted true copies of these records for use in court.
